(19) United States
(12) Patent Application Publication
(10) Pub. No.: US 2013/0083175 A1
(43) Pub. Date: Apr. 4, 2013

(54) COMPUTING DEVICE AND METHOD FOR CONTROLLING MOTION OF MECHANICAL ARM

(71) Applicants: SHEN-CHUN LI, Tu-Cheng (TW); CHUN-NENG LIAO, Tu-Cheng (TW); WEN-LAING TSENG, Tu-Cheng (TW); HSIEN-CHUAN LIANG, Tu-Cheng (TW); CHENG-HSIEN LEE, Tu-Cheng (TW); SHOU-KUO HSU, Tu-Cheng (TW)

(72) Inventors: SHEN-CHUN LI, Tu-Cheng (TW); CHUN-NENG LIAO, Tu-Cheng (TW); WEN-LAING TSENG, Tu-Cheng (TW); HSIEN-CHUAN LIANG, Tu-Cheng (TW); CHENG-HSIEN LEE, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 13/531,035

(22) Filed: Jun. 22, 2012

(30) Foreign Application Priority Data
Oct. 3, 2011 (TW) 100135695

(51) Int. Cl. H04N 7/18

(52) U.S. Cl. 348/61; 348/E07.085; 901/2

(57) ABSTRACT

In a method for controlling motion of a mechanical arm, the method moves the mechanical arm horizontally or vertically so that an image capturing device of the mechanism arm focuses on an object. The contours of the object are analyzed, and a central area of the object is established. By making the center of the image area of the image capturing device coincide with the center area of the object at least twice, the method records two positions of the mechanical arm, and calculates a total apparent displacement value of the object and a distance between the object and camera lens of the image capturing device according to the first position, the second position of the mechanical arm and the total apparent displacement value of the object. The method ensures accurate positioning of the mechanical arm.

### BACKGROUND

1. Technical Field

Embodiments of the present disclosure generally relate to measurement systems, and more particularly to a computing device and a method for controlling the motion of a mechanical arm to measure objects.

2. Description of Related Art

A mechanical arm may be used to examine an object. The object must be positioned on a test platform, and removed from the test platform when the examination is finished. During testing of the object positioned on the test platform, a central reference point of the end of the mechanical arm is hard to establish in relation to a center of the object. Therefore, improvements are desirable to improve the examination process.

### BRIEF DESCRIPTION OF THE DRAWINGS

FIG. 1 is a block diagram of one embodiment of a computing device including a motion control unit.

FIG. 2 is a block diagram of one embodiment of function modules of the motion control unit in FIG. 1.

FIG. 3 is a schematic diagram illustrating a mechanical arm on which an image capturing device is installed.

FIG. 4 is a flowchart illustrating one embodiment of a method for controlling motion of a mechanical arm by the computing device of FIG. 1.

FIG. 5 and FIG. 6 are schematic diagrams illustrating a correlation between an actual object and an image area of the image capturing device in FIG. 3.

FIG. 7 is a schematic diagram illustrating a positional relationship, marked by symbols, between an object and an image area of the image capturing device.

FIG. 8 is a schematic diagram illustrating an angular relationship, marked by symbols, between an object and an image area of the image capturing device.

### DETAILED DESCRIPTION

In general, the term “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or computer storage device. The term “memory module” as used herein, may refer to individual pieces (sticks) of hardware with a memory function in a computing system.

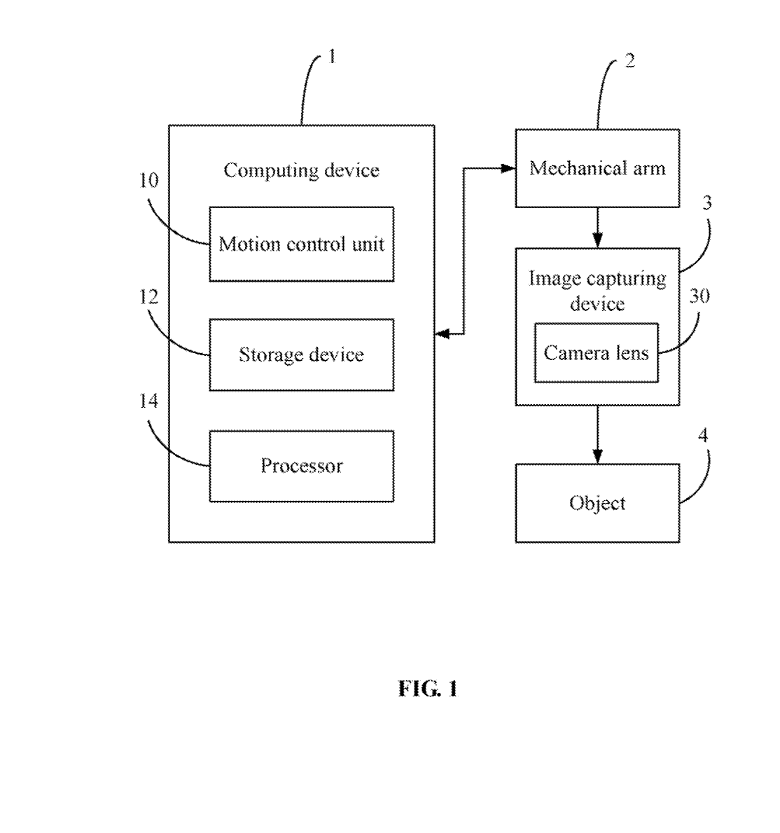

FIG. 1 is a block diagram of one embodiment of a computing device 1 including a motion control unit 10. The computing device 1 further includes a storage device 12, and at least one processor 14. In the embodiment, the computing device 1 is electronically connected to a mechanical arm 2, and controls the mechanical arm 2 to measure an object 4 using an image capturing device 3, such as a camera.

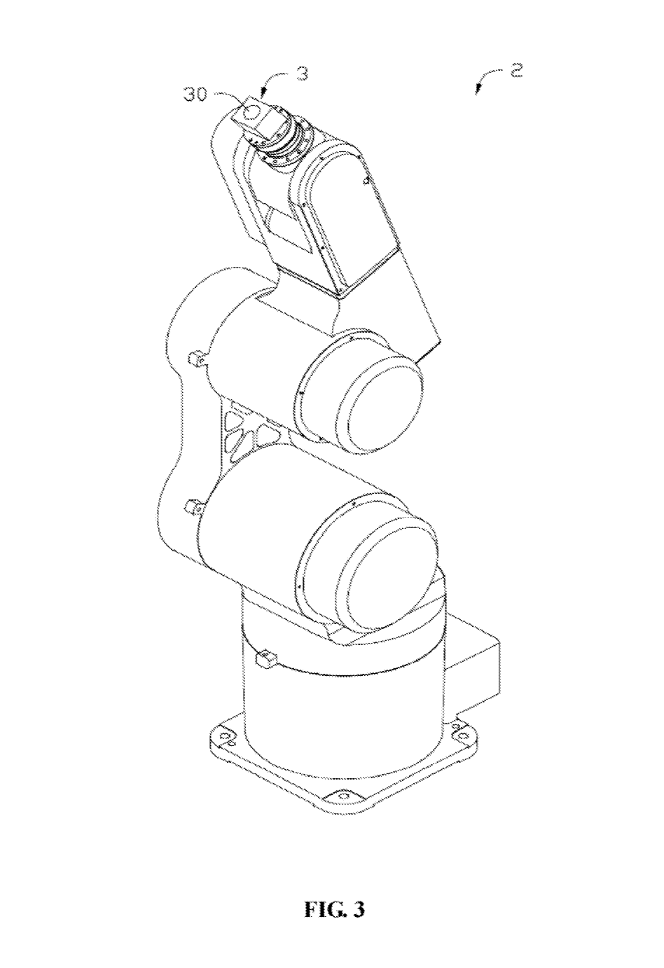

In one end of the mechanical arm 2, as shown in FIG. 3, the image capturing device 3 is installed on or near the end effector (if applicable) of the mechanical arm 2, for example, the image capturing device 3 is installed on a fixing part that is in a flange surface of the mechanical arm 2. The image capturing device 3 includes a camera lens 30. In one embodiment, the mechanical arm 2 can be jointed or non-jointed.

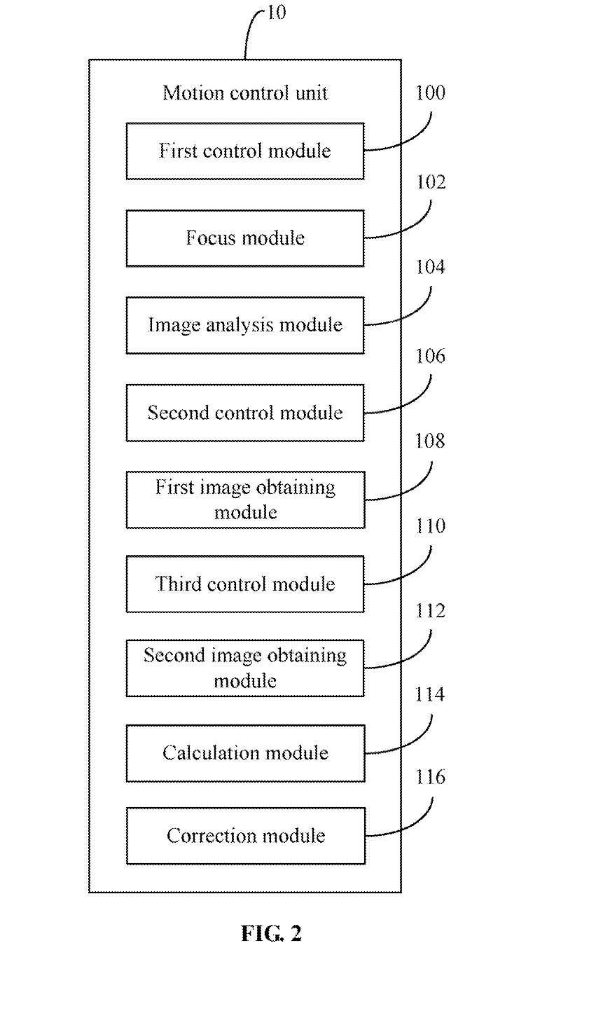

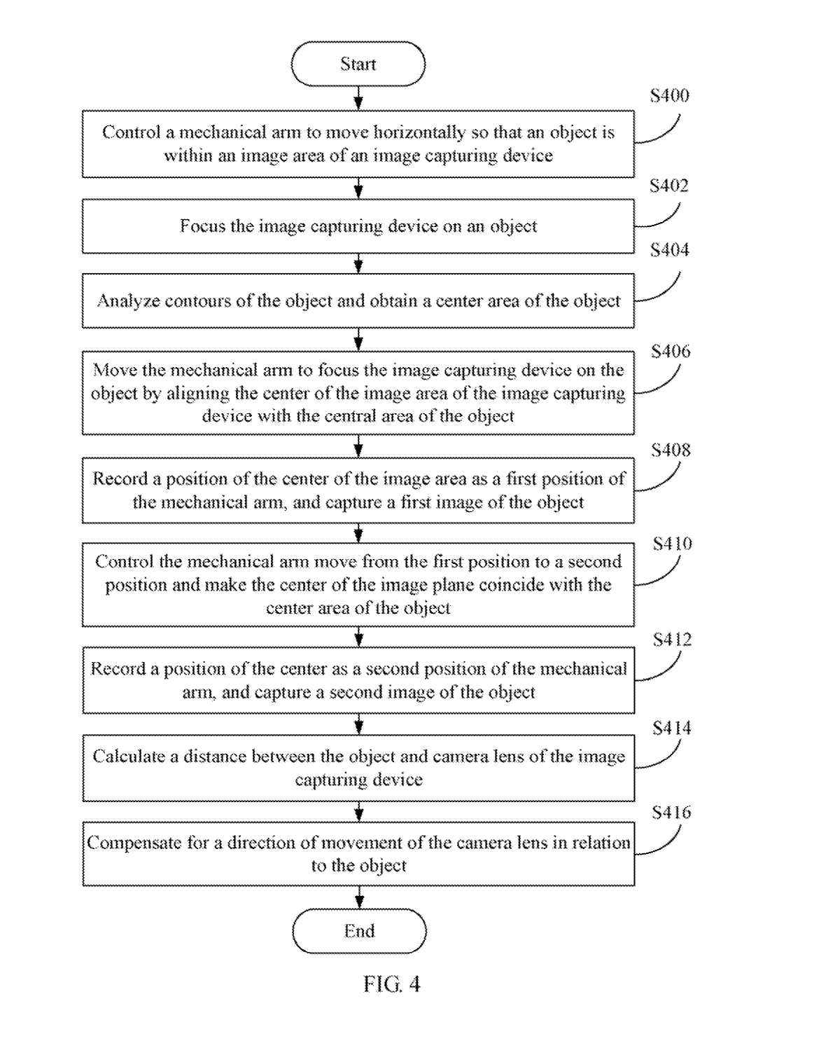

In the embodiment, the motion control unit 10 is stored in the storage device 12. Functions of the motion control unit 10 are described below and in FIG. 2 and FIG. 4.

In one embodiment, the storage device 12 may be a magnetic or an optical storage device, such as a hard disk drive, an optical drive, a compact disc, a digital video disc, a tape drive, or other suitable storage medium. The processor 16 may be a central processing unit including a math co-processor, for example. The computing device 1 may be a server, a computer, a portable electronic device, or any other data processing device.

FIG. 2 is a block diagram of one embodiment of function modules of the motion control unit 10 in FIG. 1. In the embodiment, the motion control unit 10 includes a first control module 100, a focus module 102, an image analysis module 104, a second control module 106, a first image obtaining module 108, a third control module 110, a second image obtaining module 112, a calculation module 114, and a correction module 116. Each of the modules 100-116 may be a software program including one or more computerized instructions that are stored in the storage device 12 and executed by the processor 14 to provide functions of the computing device 1.

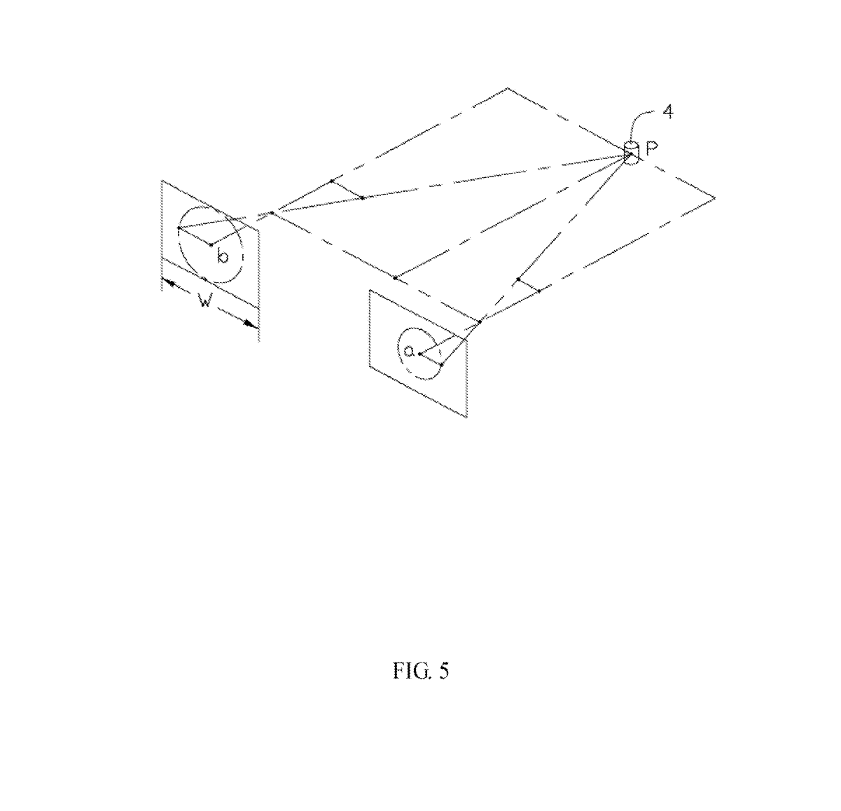

The first control module 100 controls the mechanical arm 2 to move horizontally so that the object 4 is within an image area of the image capturing device 3. The image area is illustrated in FIG. 5, the letter W represents a width of the image area.

The focus module 102 focuses the image capturing device 3 on the object 4. In detail, the focus module 102 controls the mechanical arm 2 to move, so that the image capturing device 3 is controlled to move forward or back along a imaginary line from approximate center of the object 4 to middle of the camera lens 30, and the object 4 is placed within a range of depth of field of the camera lens 30. The focus module 102 further determines an optimum image sharpness for capturing images of the object 4 based on a dimensional histogram statistic method.

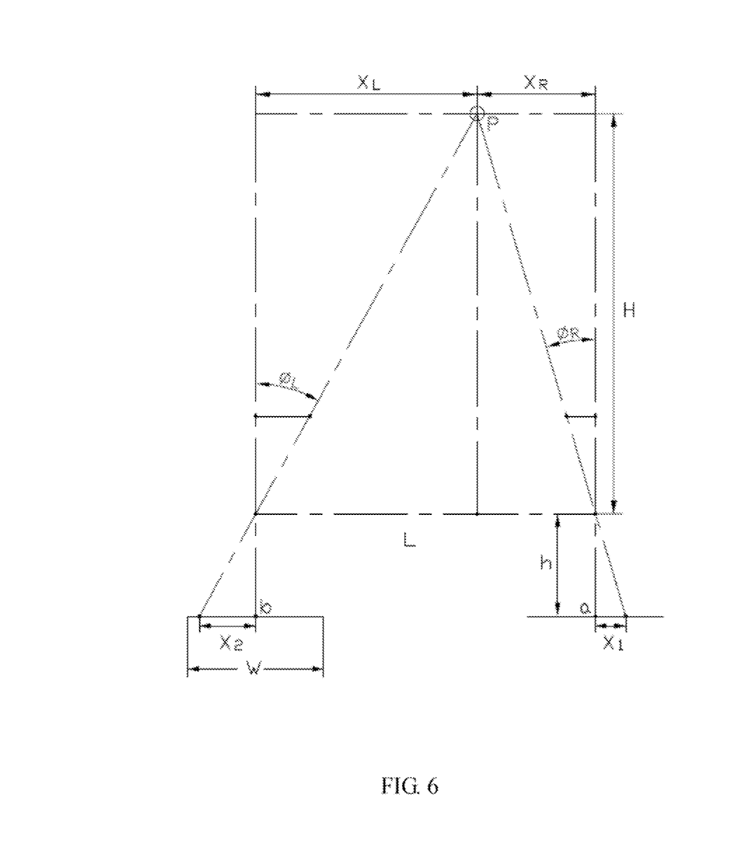

The image analysis module 104 analyzes contours of the object 4 and obtains a central area of the object 4 according to the contours of the object 4. As shown in FIG. 5 and FIG. 6, point P indicates the central area of the object 4.

The second control module 106 moves the mechanical arm 2 to focus the image capturing device 3 on the object 4 by aligning the center of the image area (shown as point “a” in FIG. 5, hereinafter the center “a”) of the image capturing device 3 with the central area of the object 4. In the embodiment, once the center “a” of the image area of the image capturing device 3 is aligned with the central area of the object 4, the center “a” of the image area of the image capturing device 3 coincides with the central area of the object 4, namely the center “a” of the image area and the central area of the object 4 are in a same line.

The first image obtaining module 108 records a position of the center “a” of the image area of the image capturing device 3 as a first position of the mechanical arm 2, and captures a first image of the object 4 using the camera lens 30 of the image capturing device 3 when the central area of the object 4 coincides with the center “a” of the image area.

The third control module 110 controls the mechanical arm 2 to move from the first position to a second position over a distance L (as shown in FIG. 6), and adjusts the position of the mechanical arm 2, so as to align the center (shown as point “b” in FIG. 5, hereinafter the center “b”)of the image area of the image capturing device 3 with the central area of the object 4.

The second image obtaining module 112 records a position of the center “b” of the image area of the image capturing device 3 as the second position of the mechanical arm 2, and captures a second image of the object 4 using the camera lens 30.

The calculation module 114 calculates a total apparent displacement value of the object 4, and calculates a distance between the object 4 and the camera lens 30 according to the first position, the second position of the mechanical arm 2 and the total apparent displacement value of the object 4.

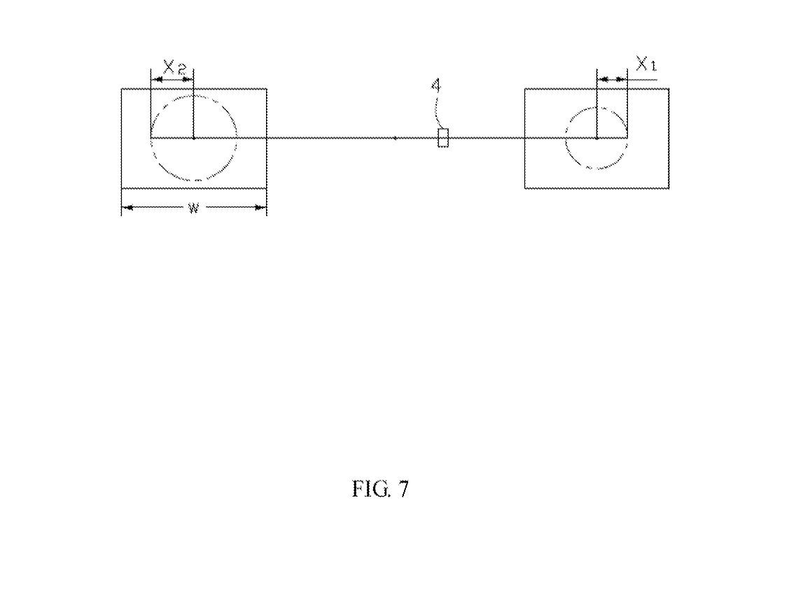

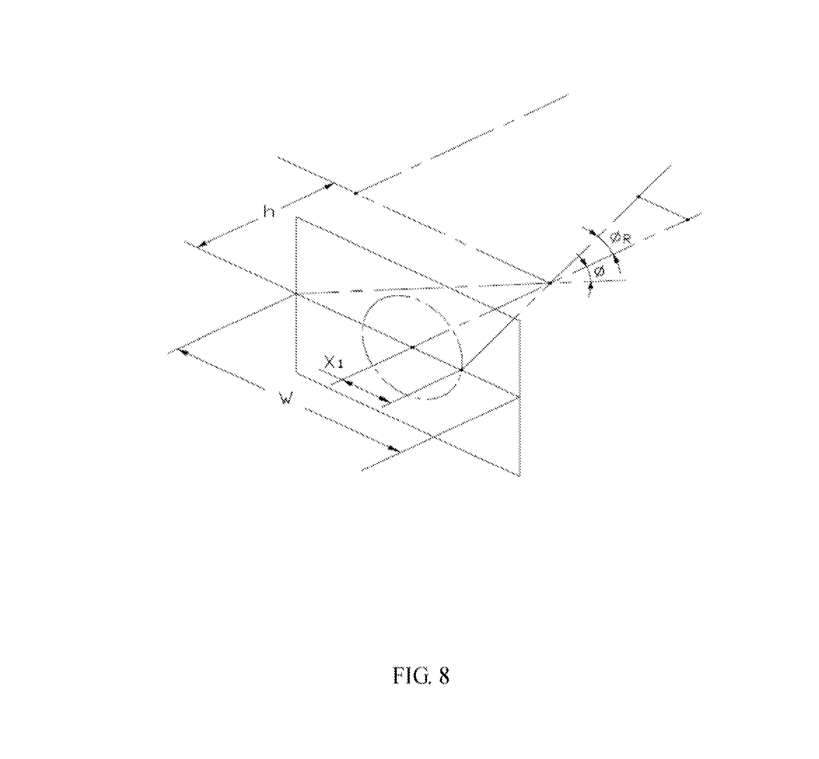

For example, as shown in FIG. 7, when the central area of the object 4 coincides with the center “a” of the image area, X1 is the distance between the center “a” and a point to the rightmost point of the object 4, wherein the center “a” and the point to the rightmost point of the object 4 are horizontally level. When the central area of the object 4 coincides with the center “b” of the image area, X2 is the distance between the center “b” and a point to the leftmost point of the object 4, wherein the center “b” and the point to the leftmost point of the object 4 are horizontally level. The calculation module 114 calculates that the total apparent displacement value of the object 4 is equal to the sum of the distances X1 and X2, i.e., X1+X2. According to FIG. 6, the calculation module 114 calculates the distance between the object 4 and the camera lens 30 using the following formulas:

$$tan ( {φ}_{R} ) = \frac{XR}{H} = \frac{X 1}{h} , tan ( {φ}_{L} ) = \frac{XL}{H} = \frac{X 2}{h} , L = XR + XL . \\ In Fig .8 , tan ( φ ) = \frac{W}{2 h} . Thus , \\ \begin{matrix}XR = \frac{H \cdot X 1}{h} \& XL \\ = \frac{H \cdot X 2}{h} ⇒ L \\ = \frac{H}{h} ( X 1 + X 2 ) ⇒ H \\ = \frac{L \cdot h}{X 1 + X 2} \\ = \frac{L}{X 1 + X 2} \cdot \frac{W}{2 \cdot tan ( φ )} ,\end{matrix}$$

where H is the distance between the central area P of the object 4 and the camera lens 30 in the vertical direction, and L is the distance between the center “a” of the image area and the center “b” of the image area. W is a width of the image area of the image capturing device 3, and h is a distance between the image area of the image capturing device 3 and the camera lens 30.

The correction module 116 compensates for the direction of movement of the camera lens 30 in relation to the object 4 by adjusting the mechanical arm 2 according to the distance between the central area P of the object 4 and the camera lens 30 in the vertical direction. For example, the correction module 116 enables a normal direction of the camera lens 30 parallel to a normal direction of the object 4 by adjusting the mechanical arm 2.

FIG. 4 is a flowchart illustrating one embodiment of a method for controlling the motion of the mechanical arm 2 using the computing device 1 of FIG. 1. Depending on the embodiment, additional steps may be added, others removed, and the ordering of the blocks may be changed.

In step S400, the first control module 100 controls the mechanical arm 2 to move horizontally so that the object 4 is within an image area of the image capturing device 3. The image area is illustrated in FIG. 5, the letter W represents a width of the image area.

In step S402, the focus module 102 focuses the image capturing device 3 on the object 4. In detail, the focus module 102 controls the mechanical arm 2 to move, so that the image capturing device 3 is controlled to move forward or back along a imaginary line from approximate center of the object 4 to middle of the camera lens 30, and the object 4 is placed within a range of depth of field of the camera lens 30. The focus module 102 further determines an optimum image sharpness for capturing images of the object 4 based on a dimensional histogram statistic method.

In step S404, the image analysis module 104 analyzes contours of the object 4, and obtains a central area of the object 4 according to the contours of the object 4. As shown in FIG. 5 and FIG. 6, the central area of the object 4 is indicated as a point P.

In step S406, the second control module 106 moves the mechanical arm 2 to focus the image capturing device 3 on the object 4 by aligning the center of the image area (shown as point “a” in FIG. 5, hereinafter the center “a”) of the image capturing device 3 with the central area of the object 4. In the embodiment, once the center “a” of the image area of the image capturing device 3 is aligned with the central area of the object 4, the center “a” of the image area of the image capturing device 3 coincides with the central area of the object 4, namely the center “a” of the image area and the central area of the object 4 are in a same line.

In step S408, the first image obtaining module 108 records a position of the center “a” of the image area as a first position of the mechanical arm 2, and captures a first image of the object 4 using the camera lens 30 of the image capturing device 3.

In step S410, the third control module 110 controls the mechanical arm 2 to move from the first position to a second position over a distance L (as shown in FIG. 6), and adjusts the position of the mechanical arm 2 so as to make the center (shown as point “b” in FIG. 5, hereinafter the center “b”) of the image area of the image capturing device 3 coincide with the central area of the object 4.

In step S412, the second image obtaining module 112 records a position of the center “b” of the image area as a second position of the mechanical arm 2, and captures a second image of the object 4 using the camera lens 30 of the image capturing device 3.

In step S414, the calculation module 114 calculates a total apparent displacement value of the object 4 in the image area, and calculates a distance between the object 4 and the camera lens 30 according to the first position, the second position of the mechanical arm 2, and the total apparent displacement value of the object 4.

In step S416, the correction module 116 compensates for the direction of movement of the camera lens 30 in relation to the object 4 by adjusting the mechanical arm 2 according to the distance between the central area P of the object 4 and the camera lens 30 in the vertical direction.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method of a computing device for controlling motions of a mechanical arm, the method comprising steps of:
controlling the mechanical arm to move horizontally so that an object is within an image area of an image capturing device, the image capturing device being positioned on an end of the mechanical arm;
focusing the image capturing device on the object by controlling the mechanical arm to move;
analyzing contours of the object and obtaining a center area of the object;
moving the mechanical arm to focus the image capturing device on the object by aligning the center of the image area of the image capturing device with the central area of the object;
recording a position of the center of the image area as a first position of the mechanical arm, and capturing a first image of the object using the image capturing device when the center area of the object is aligned with the center of the image area;
controlling the mechanical arm to move from the first position to a second position over a moving distance, and making the center of the image area of the image capturing device coincide with the center area of the object by adjusting a position of the mechanical arm;
recording a position of the center of the image area as the second position of the mechanical arm, and capturing a second image of the object using the image capturing device when the center area of the object coincides with the center of the image area;
calculating a total apparent displacement value of the object in the image area, and calculating a distance between the object and a camera lens of the image capturing device according to the first position, the second position of the mechanical arm and the total apparent displacement value of the object; and
compensating for a direction of movement of the camera lens in relation to the object by adjusting the mechanical arm according to the distance between the central area of the object and the camera lens in the vertical direction.

2. The method as described in claim 1, wherein the focusing step comprises:
controlling the mechanical arm to move so that the image capturing device is controlled to move forward or back along a imaginary line from approximate center of the object to middle of the camera lens;
placing the object within a range of depth of field of the camera lens; and
determining an optimum image sharpness for capturing images of the object based on a dimensional histogram statistic method.

3. The method as described in claim 1, wherein the image capturing device is installed on a fixing part that is in a flange surface of the mechanical arm.

4. The method as described in claim 1, wherein the step of making the center of the image area of the image capturing device coincide with the center area of the object further comprising the steps of:
controlling the mechanical arm to move; and
focusing the image capturing device on the object.

5. The method as described in claim 1, wherein the mechanical arm is jointed, or non-jointed.

6. A computing device, comprising:
a storage device;
at least one processor; and
one or more modules that are stored in the storage device and executed by the at least one processor, the one or more modules comprising:
a first control module that controls the mechanical arm to move horizontally so that an object is within an image area of an image capturing device, the image capturing device being positioned on an end of the mechanical arm;
a focus module that focuses the image capturing device on the object by controlling the mechanical arm to move;
an image analysis module that analyzes contours of the object and obtaining a center area of the object;
a second control module that moves the mechanical arm to focus the image capturing device on the object by aligning the center of the image area of the image capturing device with the central area of the object;
a first image obtaining module that records a position of the center of the image area as a first position of the mechanical arm, and captures a first image of the object using the image capturing device when the center area of the object is aligned with the center of the image area;
a third control module that controls the mechanical arm to move from the first position to a second position over a moving distance, and makes the center of the image area of the image capturing device coincide with the center area of the object by adjusting a position of the mechanical arm;
a second image obtaining module that records a position of the center of the image area as a second position of the mechanical arm, and captures a second image of the object using the image capturing device when the center area of the object coincides with the center of the image area;
a calculation module that calculates a total apparent displacement value of the object in the image area, and calculates a distance between the object and a camera lens of the image capturing device according to the first position, the second position of the mechanical arm and the total apparent displacement value of the object; and
a correction module that compensates for a direction of movement of the camera lens in relation to the object by adjusting the mechanical arm according to the distance between the central area of the object and the camera lens in the vertical direction.

7. The computing device as described in claim 6, wherein the focus module focuses the image capturing device on the object by executing the following steps:
controlling the mechanical arm to move so that the image capturing device is controlled to move forward or back along a imaginary line from approximate center of the object to middle of the camera lens;
placing the object within a range of depth of field of the camera lens; and
determining an optimum image sharpness for capturing images of the object based on a dimensional histogram statistic method.

8. The computing device as described in claim 6, wherein the image capturing device is installed on a fixing part that is in a flange surface of the mechanical arm.

9. The computing device as described in claim 6, wherein the focus module further controls the mechanical arm to move and focuses the image capturing device on the object, after the center of the image area of the image capturing device is coincided with the center area of the object.

10. The computing device as described in claim 6, wherein the mechanical arm is jointed or non-jointed.

11. A non-transitory computer readable storage medium having stored thereon instructions that, when executed by a processor of a computing device, causes the processor to perform a method of controlling motions of a mechanical arm, the method comprising steps of:
controlling the mechanical arm to move horizontally so that an object is within an image area of an image capturing device, the image capturing device being positioned on an end of the mechanical arm;
focusing the image capturing device on the object by controlling the mechanical arm to move;
analyzing contours of the object and obtaining a center area of the object;
moving the mechanical arm to focus the image capturing device on the object by aligning the center of the image area of the image capturing device with the central area of the object;
recording a position of the center of the image area as a first position of the mechanical arm, and capturing a first image of the object using the image capturing device when the center area of the object is aligned with the center of the image area;
controlling the mechanical arm to move from the first position to a second position over a moving distance, and making the center of the image area of the image capturing device coincide with the center area of the object by adjusting a position of the mechanical arm;
recording a position of the center of the image area as the second position of the mechanical arm, and capturing a second image of the object using the image capturing device when the center area of the object coincides with the center of the image area;
calculating a total apparent displacement value of the object in the image area, and calculating a distance between the object and a camera lens of the image capturing device according to the first position, the second position of the mechanical arm and the total apparent displacement value of the object; and
compensating for a direction of movement of the camera lens in relation to the object by adjusting the mechanical arm according to the distance between the central area of the object and the camera lens in the vertical direction.

12. The storage medium as described as described in claim 11, wherein the focusing step comprises:
controlling the mechanical arm to move so that the image capturing device is controlled to move forward or back along a imaginary line from approximate center of the object to middle of the camera lens;
placing the object within a range of depth of field of the camera lens; and
determining an optimum image sharpness for capturing images of the object based on a dimensional histogram statistic method.

13. The storage medium as described as described in claim 11, wherein the image capturing device is installed on a fixing part that is in a flange surface of the mechanical arm.

14. The storage medium as described as described in claim 11, wherein the step of making the center of the image area of the image capturing device coincide with the center area of the object further comprises steps of:
controlling the mechanical arm to move; and
focusing the image capturing device on the object.

15. The storage medium as described as described in claim 11, wherein the mechanical arm is jointed or non-jointed.
